(19) United States
(12) Patent Application Publication
(10) Pub. No.: US 2023/0312941 A1
(43) Pub. Date: Oct. 5, 2023

(54) REDUCING THE DETECTABLE CROSS-SECTION OF AN OBJECT

(71) Applicant: James R. Cartiglia, Brentwood, TN (US)

(72) Inventor: James R. Cartiglia, Brentwood, TN (US)

(21) Appl. No.: 17/712,089

(22) Filed: Apr. 2, 2022

(51) Int. Cl. C09D 5/30; C01B 32/225; C09D 7/61; C09D 7/40; B05D 1/02

(52) U.S. Cl. CPC C09D 5/30; C01B 32/225; C09D 7/61; C09D 7/70; B05D 1/02; C01P 2004/24; C08K 3/04

(57) ABSTRACT

A composition for reducing the detectable cross-section of an object, which includes graphite selected from the group consisting of graphite flakes, particles of exfoliated graphite, graphitic nano-structures, and combinations of one or more thereof, wherein the graphite is dispersed in a coating composition. Also included are objects to which the composition are applied, and a process for reducing the detectable cross-section of an object.

### TECHNICAL FIELD

This disclosure relates to compositions and processes for reducing the detectable cross-section of an object, such as a manned or unmanned aircraft, vessel, structure, land or water vehicle, or other device or object. These compositions and processes can reduce the detection of any such object, and can be applied during manufacture of an object or to retrofit an object that has completed the manufacturing process.

### BACKGROUND

Detection avoidance technologies, also known as stealth technologies, include radar stealth, infrared stealth, laser stealth (including infrared laser stealth), sound stealth, and visible light stealth; there can also be the need for radio frequency stealth, in those cases where an object's electronic signature can be tracked. Currently, the primary need remains in the arena of radar and infrared detection. Stealth technology research also focuses on achieving radar and infrared stealth while controlling other signal characteristics such as laser, sound, visible light, etc., in order to obtain multifunctional, high-performance stealth functional materials and structural materials.

Many current technical approaches revolve around absorption techniques that require high absorption and low reflection of materials, but such absorbed electromagnetic energy can be converted to thermal energy, which increases the surface temperature of an object and can increase recognition by infrared detectors. In addition, infrared stealth often requires low absorption and high reflection of the material, which makes the radar wave directly reflected back on the surface of the material, and the radar shealth effect is not achieved.

### BRIEF SUMMARY

In an embodiment, the present disclosure relates to compositions and processes for reducing the detectable cross-section of an object, which includes providing particles of graphite on at least part of the surface of the object. In some embodiments, the particles of graphite are flakes of graphite; in other embodiments, the particles of graphite are particles of exfoliated graphite (sometimes referred to as graphite “worms”); in still other embodiments, the particles of graphite are graphitic nano-structures. In some embodiments, a combination of two or more of natural graphite flakes, particles of exfoliated graphite, and graphitic nano-structures are employed.

In certain embodiments, the particles of graphite are dispersed in a coating composition, such as a coating or paint, which can be applied to the object. In some embodiments, the particles of graphite are contained in a paint applied to the object; in other embodiments, the graphite particles are contained in a primer; and in still other embodiments, the particles are in an overcoat.

In particular embodiments, the present disclosure relates to a composition for reducing the detectable cross-section of an object, which comprises graphite selected from the group consisting of graphite flakes, particles of exfoliated graphite, graphitic nano-structures, and combinations of one or more thereof, wherein the graphite is dispersed in a coating composition. In some embodiments, the graphite comprises graphite flakes having a degree of graphitization of about 1.0, particles of exfoliated graphite produced from graphite flakes having a degree of graphitization of about 1.0, graphitic nano-structures produced from graphite flakes having a degree of graphitization of about 1.0, and combinations of one or more thereof. Furthermore, in embodiments, the graphite comprises graphite flakes having a purity of at least about 98%, particles of exfoliated graphite produced from graphite flakes having a purity of at least about 98%, graphitic nano-structures produced from graphite flakes having a purity of at least about 98%, and combinations of one or more thereof.

The certain embodiment, graphite is present in the coating composition at a level of about 5 to about 170 parts by weight per 100 parts by weight of coating composition; in other embodiments, the graphite is present at a level of about 30 to about 100 parts by weight per 100 parts by weight of coating composition. The graphite is randomly dispersed in the coating composition.

The coating composition can also have dispersed thereinto metals selected from the group consisting of aluminum, copper, nickel, iron, and combinations thereof, in some embodiments. The metals can be present at a level of about 2 to about 30 parts by weight per 100 parts of the coating composition.

In some embodiments, the coating composition, with graphite dispersed thereinto, is applied to the object by spraying.

### DETAILED DESCRIPTION

Reference now will be made in detail to the embodiments of the present disclosure. It will be apparent to those skilled in the art that various modifications and variations can be made to the teachings of the present disclosure without departing from the scope of the disclosure. For instance, features illustrated or described as part of one embodiment, can be used with another embodiment to yield a still further embodiment.

Thus, it is intended that the present disclosure covers such modifications and variations as come within the scope of the appended claims and their equivalents. Other objects, features and aspects of the present disclosure are disclosed in or are apparent from the following detailed description. It is to be understood by one of ordinary skill in the art that the present discussion is a description of exemplary embodiments only and is not intended as limiting the broader aspects of the present disclosure.

What is presented are compositions and processes for reducing the detectable cross-section of an object using particles of graphite. In some embodiments, the object is a manned or unmanned aircraft; in other embodiments, the object is a ground or water vehicle; in yet other embodiments, the object is a stationary object, such as a building or structure. The particles of graphite are, in certain embodiments, flakes of natural graphite; in some embodiments, the particles of graphite are particles of exfoliated graphite (sometimes referred to as graphite “worms”), in yet other embodiments, the particles of graphite are graphitic nano-structures. In other embodiments, a combination of two or more of natural graphite flakes, particles of exfoliated graphite, and graphitic nano-structures are utilized.

### Graphite

Graphites are made up of layer planes of hexagonal arrays or networks of carbon atoms. These layer planes of hexagonally arranged carbon atoms are substantially flat and are oriented or ordered so as to be substantially parallel and equidistant to one another. The substantially flat, parallel equidistant sheets or layers of carbon atoms, usually referred to as graphene layers or basal planes, are linked or bonded together and groups thereof are arranged in crystallites. Highly ordered graphites consist of crystallites of considerable size: the crystallites being highly aligned or oriented with respect to each other and having well ordered carbon layers. In other words, highly ordered graphites have a high degree of preferred crystallite orientation. It should be noted that graphites possess anisotropic structures and thus exhibit or possess many properties that are highly directional, such as thermal and electrical conductivity. Briefly, graphites may be characterized as laminated structures of carbon, that is, structures consisting of superposed layers or laminae of carbon atoms joined together by weak van der Waals forces.

Graphites suitable for use herein is formed of layered planes of hexagonal arrays or networks of carbon atoms, with extremely strong bonds within the layers, and relatively weak bonding between the layers. The carbon atoms in each layer plane (generally referred to as basal planes or graphene layers) are arranged hexagonally such that each carbon atom is covalently bonded to three other carbon atoms, leading to high intra-layer strength. However, as noted, the bonds between the layers are weak van der Waals forces (which are less than about 0.4% of the strength of the covalent bonds in the layer plane). Accordingly, because these inter-layer bonds are so weak as compared to the covalent intra-layer bonds, the spacing between layers of the graphite particles can be chemically or electrochemically treated so as to be opened up to provide a substantially expanded particle while maintaining the planar dimensions of the graphene layers.

In considering the graphite structure, two axes or directions are usually noted, to wit, the “c” axis or direction and the “a” axes or directions. For simplicity, the “c” axis or direction may be considered as the direction perpendicular to the carbon layers. The “a” axes or directions may be considered as the directions parallel to the carbon layers or the directions perpendicular to the “c” direction.

Graphite materials suitable for use in the present disclosure include highly graphitic carbonaceous materials capable of intercalating organic and inorganic acids as well as halogens and then expanding when exposed to heat. These highly graphitic carbonaceous materials have, in some embodiments, a degree of graphitization of about 1.0. As used in this disclosure, the term “degree of graphitization” refers to the value g according to the formula:

$$g = \frac{3.45 - d ( 002 )}{0.095}$$

where d(002) is the spacing between the graphitic layers of the carbons in the crystal structure measured in Angstroms. The spacing d between graphite layers is measured by standard X-ray diffraction techniques. The positions of diffraction peaks corresponding to the (002), (004) and (006) Miller Indices are measured, and standard least-squares techniques are employed to derive spacing which minimizes the total error for all of these peaks. Examples of highly graphitic carbonaceous materials include natural graphites from various sources, as well as other carbonaceous materials such as graphite prepared by chemical vapor deposition, high temperature pyrolysis of polymers, or crystallization from molten metal solutions and the like. In certain embodiments, natural graphite is employed in the materials and processes of the present disclosure.

The graphite materials used in the present disclosure may contain non-graphite components so long as the crystal structure of the starting materials maintains the required degree of graphitization and they are capable of exfoliation. Generally, any carbon-containing material, the crystal structure of which possesses the required degree of graphitization and which can be exfoliated, is suitable for use with the present disclosure. In embodiments, such graphite has a purity of at least about eighty weight percent. In some embodiments, the graphite used for the present disclosure will have a purity of at least about 94%. In other embodiments, the graphite employed will have a purity of at least about 98%.

### Particles of Exfoliated Graphite

While in some embodiments the graphite employed in the materials and processes of the present disclosure comprises particles of graphite (i.e., unexfoliated graphite), in some embodiments the graphite comprises particles of exfoliated graphite. As noted above, the bonding forces holding the parallel layers of carbon atoms together are only weak van der Waals forces. Graphite materials suitable for use in this disclosure, as described above, can be treated so that the spacing between the superposed carbon layers or laminae can be appreciably opened up so as to provide a marked expansion in the direction perpendicular to the layers, that is, in the “c” direction, and thus form an expanded or intumesced graphite structure in which the laminar character of the carbon layers is substantially retained.

By treating particles of graphite, such as natural graphite flake, with an intercalant of, e.g., a solution of sulfuric and nitric acid, the crystal structure of the graphite reacts to form a compound of graphite and the intercalant. The treated particles of graphite are hereafter referred to as “particles of intercalated graphite”, sometimes also referred to as “graphite intercalation compounds” (“GICs”). Upon exposure to high temperature, the intercalant within the graphite decomposes and volatilizes, causing the particles of intercalated graphite to expand in one dimension as much as about 80 or more times its original volume in an accordion-like fashion in the “c” direction, i.e., in the direction perpendicular to the crystalline planes of the graphite. The exfoliated graphite particles are vermiform in appearance, and are therefore commonly referred to as “worms”.

One method for manufacturing particles of exfoliated graphite is described by Shane et al. in U.S. Pat. No. 3,404,061, the disclosure of which is incorporated herein by reference. In the typical practice of the Shane et al. method, natural graphite flakes are intercalated by dispersing the flakes in a solution containing e.g., a mixture of nitric and sulfuric acid, advantageously at a level of about 20 to about 300 parts by weight of intercalant solution per 100 parts by weight of graphite flakes (pph). The intercalation solution contains oxidizing and other intercalating agents known in the art. Examples include those containing oxidizing agents and oxidizing mixtures, such as solutions containing nitric acid, potassium chlorate, chromic acid, potassium permanganate, potassium chromate, potassium dichromate, perchloric acid, and the like, or mixtures, such as for example, concentrated nitric acid and chlorate, chromic acid and phosphoric acid, sulfuric acid and nitric acid, or mixtures of a strong organic acid, e.g. trifluoroacetic acid, and a strong oxidizing agent soluble in the organic acid. Alternatively, an electric potential can be used to bring about oxidation of the graphite. Chemical species that can be introduced into the graphite crystal using electrolytic oxidation include sulfuric acid as well as other acids.

In one embodiment, the intercalating agent is a solution of a mixture of sulfuric acid, or sulfuric acid and phosphoric acid, and an oxidizing agent, i.e., nitric acid, perchloric acid, chromic acid, potassium permanganate, hydrogen peroxide, iodic or periodic acids, or the like. In other embodiments, the intercalation solution may contain metal halides such as ferric chloride, and ferric chloride mixed with sulfuric acid, or a halide, such as bromine as a solution of bromine and sulfuric acid or bromine in an organic solvent.

The quantity of intercalation solution may range from about 20 to about 350 pph and more typically about 40 to about 160 pph. After the graphite particles or flakes are intercalated, any excess solution is drained from the flakes and the flakes are water-washed. In some embodiments, the quantity of the intercalation solution may be limited to between about 10 and about 40 pph, which permits the washing step to be eliminated as taught and described in U.S. Pat. No. 4,895,713, the disclosure of which is also herein incorporated by reference.

The particles of graphite treated with intercalation solution can optionally be contacted, such as by blending, with a reducing organic agent selected from alcohols, sugars, aldehydes and esters which are reactive with the surface film of oxidizing intercalating solution at temperatures in the range of 25° C. and 125° C. Suitable specific organic agents include hexadecanol, octadecanol, 1-octanol, 2-octanol, decylalcohol, 1,10 decanediol, decylaldehyde, 1-propanol, 1,3 propanediol, ethyleneglycol, polypropylene glycol, dextrose, fructose, lactose, sucrose, potato starch, ethylene glycol monostearate, diethylene glycol dibenzoate, propylene glycol monostearate, glycerol monostearate, dimethyl oxylate, diethyl oxylate, methyl formate, ethyl formate, ascorbic acid and lignin-derived compounds, such as sodium lignosulfate. The amount of organic reducing agent can in some embodiments be from about 0.5 to 4% by weight of the particles of graphite.

In some embodiments, the use of an expansion aid applied prior to, during, or immediately after intercalation can also provide improvements. Among these improvements can be reduced exfoliation temperature and increased expanded volume (also referred to as “worm volume”). An expansion aid in this context can in certain embodiments be an organic material sufficiently soluble in the intercalation solution to achieve an improvement in expansion. More narrowly, organic materials of this type that contain carbon, hydrogen and oxygen, preferably exclusively, may be employed.

Carboxylic acids have been found effective in some embodiments. A suitable carboxylic acid useful as the expansion aid can be selected from aromatic, aliphatic or cycloaliphatic, straight chain or branched chain, saturated and unsaturated monocarboxylic acids, dicarboxylic acids and polycarboxylic acids which have at least 1 carbon atom, and preferably up to about 15 carbon atoms, which is soluble in the intercalation solution in amounts effective to provide a measurable improvement of one or more aspects of exfoliation. Suitable organic solvents can be employed to improve solubility of an organic expansion aid in the intercalation solution.

Representative examples of saturated aliphatic carboxylic acids are acids such as formic, acetic, propionic, butyric, pentanoic, hexanoic, and the like. In place of the carboxylic acids, the anhydrides or reactive carboxylic acid derivatives such as alkyl esters can also be employed. Representative of alkyl esters are methyl formate and ethyl formate. Sulfuric acid, nitric acid and other known aqueous intercalants have the ability to decompose formic acid, ultimately to water and carbon dioxide. Because of this, formic acid and other sensitive expansion aids are advantageously contacted with the graphite flake prior to immersion of the flake in aqueous intercalant. Representative of dicarboxylic acids are aliphatic dicarboxylic acids having 2-12 carbon atoms, in particular oxalic acid, fumaric acid, malonic acid, maleic acid, succinic acid, glutaric acid, adipic acid, 1,5-pentanedicarboxylic acid, 1,6-hexanedicarboxylic acid, 1,10-decanedicarboxylic acid, cyclohexane-1,4-dicarboxylic acid and aromatic dicarboxylic acids such as phthalic acid or terephthalic acid. Representative of alkyl esters are dimethyl oxylate and diethyl oxylate. Representative of cycloaliphatic acids is cyclohexane carboxylic acid and of aromatic carboxylic acids are benzoic acid, naphthoic acid, anthranilic acid, p-aminobenzoic acid, salicylic acid, o-, m- and p-tolyl acids, methoxy and ethoxybenzoic acids, acetoacetamidobenzoic acids and, acetamidobenzoic acids, phenylacetic acid and naphthoic acids. Representative of hydroxy aromatic acids are hydroxybenzoic acid, 3-hydroxy-1-naphthoic acid, 3-hydroxy-2-naphthoic acid, 4-hydroxy-2-naphthoic acid, 5-hydroxy-1-naphthoic acid, 5-hydroxy-2-naphthoic acid, 6-hydroxy-2-naphthoic acid and 7-hydroxy-2-naphthoic acid. Prominent among the polycarboxylic acids is citric acid.

The intercalation solution can be aqueous and, in embodiments, will contain an amount of expansion aid of from about 1 to 10%, the amount being effective to enhance exfoliation. In the embodiment wherein the expansion aid is contacted with the graphite flake prior to or after immersing in the aqueous intercalation solution, the expansion aid can be admixed with the graphite by suitable means, such as a V-blender, typically in an amount of from about 0.2% to about 10% by weight of the graphite flake. After intercalating the graphite flake and forming the GICs, and following the blending of the GICs with the organic reducing agent, the blend can in certain embodiments be exposed to temperatures in the range of 25° C. and 125° C. to promote reaction of the reducing agent and intercalant coating. The heating period is up to about 20 hours, with shorter heating periods, e.g., at least about 10 minutes, for higher temperatures in the above-noted range. Times of one half hour or less, e.g., on the order of 10 to 25 minutes, can be employed at the higher temperatures.

Upon exposure to high temperature, in some embodiments, temperatures of at least about 160° C. and in other embodiments about 700° C. to 1000° C. and higher, the particles of intercalated graphite expand as much as about 80 to 1000 or more times their original volume in an accordion-like fashion in the c-direction, i.e., in the direction perpendicular to the crystalline planes of the constituent graphite particles to form particles of exfoliated graphite.

The above described processes for intercalating and exfoliating graphite flake can in certain embodiments be augmented by pretreatment of the graphite flake at graphitization temperatures, i.e. temperatures in the range of about 3000° C. and above and by the inclusion in the intercalant of a lubricious additive, as described in International Patent Application No. PCT/US02/39749.

The pretreatment, or annealing, of the graphite flake can in some embodiments result in increased expansion, potentially up to 300% or greater volume, when the flake is subsequently subjected to intercalation and exfoliation.

The annealing described above is performed for a period of time sufficient to result in a flake having an enhanced degree of expansion upon intercalation and subsequent exfoliation, in embodiments. Typically, the time required will be 1 hour or more (in certain embodiments the time is from 1 to 3 hours), and will proceed in an inert environment. In some embodiments, the annealed graphite flake will also be subjected to other processes to enhance the degree of expansion—namely intercalation in the presence of an organic reducing agent, an intercalation aid such as an organic acid, and/or a surfactant wash following intercalation.

The annealing step may be performed in an induction furnace or other such apparatus as is known and appreciated in the art of graphitization.

Because it has been observed that the worms produced using graphite subjected to pre-intercalation annealing can sometimes “clump” together, which can negatively impact area weight uniformity, an additive that assists in the formation of “free flowing” worms is employed in some embodiments. The addition of a lubricious additive to the intercalation solution can in some embodiments reduce any such “clumping”.

The lubricious additive is a long chain hydrocarbon in embodiments; in certain embodiments it is a hydrocarbon having at least about 10 carbons. Other organic compounds having long chain hydrocarbon groups, even if other functional groups are present, can also be employed in other embodiments. In certain embodiments, the lubricious additive is an oil such as a mineral oil. It will be noted that certain of the expansion aids detailed above also meet the definition of a lubricious additive. When these materials are used as the expansion aid, it may not be necessary to include a separate lubricious additive in the intercalant.

In some embodiments, the lubricious additive is present in the intercalant in an amount of at least about 1.4 pph; in other embodiments it is present in the intercalant in an amount of at least about 1.8 pph. Although the upper limit of the inclusion of lubricous additive is not as critical as the lower limit, there does not appear to be any significant additional advantage to including the lubricious additive at a level of greater than about 4 pph.

Additional processes for the production of particles of exfoliated graphite are taught by, for instance, Mercuri et al. in U.S. Pat. No. 6,432,336, Kaschak et al. in International Publication No. WO 2004/108997, and Smalc et al. in U.S. Pat. No. 6,982,874, the disclosures of each of which are incorporated herein by reference.

### Graphitic Nano-Structures

When referring to graphitic nano-structures, what is meant is a structure which is, on average, no greater than about 1000 nanometers (nm), e.g., no greater than about one micron, in at least one dimension. Therefore, in the case of a nano-scale plate, the thickness (or through-plane dimension) of the plate should be no greater than about 1000 nm, while the plane of the plate can be greater, in some embodiments more than one millimeter across. Such a nano-plate would be said to have an aspect ratio (the ratio of the major (in-plane) dimension to the minor (through-plane) dimension) that is extremely high. In certain embodiments, the aspect ratio of the graphitic nano-structures can be as high as 250,000:1 or greater; in other embodiments, the aspect ratio is about 1000:1 or greater. Generally speaking, in embodiments, the aspect ratio of the graphitic nano-structures varies between 1000:1 and 500,000:1. A minor dimension of the nano-structure (for instance, the thickness of a nano-scale plate), is in some embodiments no greater than about 250 nm, in other embodiments no greater than about 20 nm.

The intercalation process described above functions to insert a volatile species between the layer planes of the graphite flake which, when exposed to high temperatures, rapidly volatilizes, causes separation of the layers and, consequently, exfoliation. Typical intercalation of graphite for the production of particles of exfoliated graphite (for instance for the production of compressed sheets of exfoliated graphite) is Stage VII or lower Stage value (as used herein, the “higher” Stage number reflects a lower intercalation value, i.e., fewer galleries and more graphene layers between galleries). The Stage Index is a measure of the average number of graphene layers between each “gallery” (the space between graphene layers in which the chemical intercalant is inserted), rounded to the nearest whole number. Therefore, in Stage VII intercalation, there are, on average, less than 7.5 graphene layers between each gallery. In Stage VIII intercalation, there are, on average, at least 7.5 graphene layers between each gallery.

The Stage Index of an intercalated graphite flake can be determined empirically by x-ray diffraction to measure the “c” lattice spacing (the spacing between any three graphene layers), where a spacing of 6.708 Angstroms (Å) indicates a non-intercalated graphite flake and over 8 Å indicates an intercalated flake with Stage I intercalation (on average, only one graphene layer separating each gallery, or as complete intercalation as possible).

Processes for preparing lower intercalation Stages (more specifically, Stage III and lower) are known. For instance, Kaschak et al. (International Publication No. WO 2004/108997) described a process for preparing Stage V (i.e., intercalation between, on average, every fifth graphene layer) or higher intercalation using supercritical fluids. Other systems for preparing intercalated graphite flakes having Stage III or higher degree intercalation (that is, intercalation to Stage I, II or III) using methanol, phosphoric acid, sulfuric acid, or simply water, combined with nitric acid in various combinations, are known, for both “normal” or “spontaneous” intercalation and electrochemical intercalation.

For instance, an admixture of up to 15% water in nitric acid can provide Stage III or II spontaneous intercalation and Stage I electrochemical intercalation; for methanol and phosphoric acid, an admixture of up to 25% in nitric acid can provide Stage II spontaneous intercalation and Stage I electrochemical intercalation. The chemical or electrochemical potential of the intercalant critically effects the thermodynamics of the process, where higher potential leads to a lower stage number (i.e., a greater degree of intercalation), while kinetic effects such as time and temperature combine to define processes which can be of commercial importance.

In an embodiment, graphitic nano-structures useful in the present disclosure are produced using Stage III or higher graphite intercalation compounds (GICs)(that is, GICs intercalated to Stage I, II or III).

The graphite flake is, in some embodiments, intercalated with an intercalant comprising formic acid, acetic acid, water, or combinations thereof, and the graphite intercalation compound is exposed to a supercritical fluid prior to exfoliation. Treatment of the Stage I intercalated flakes with a supercritical fluid like supercritical carbon dioxide can also function to reduce the tendency of the flake to “de-intercalate” to a lower degree of intercalation, and thus a lower Stage of intercalation level (such as from Stage I to Stage V). In addition, treatment of the intercalated flake with a supercritical fluid after completion of intercalation can also improve the expansion of the flake when heated, as discussed.

Since the process requires expansion of Stage I, II or III GICs, a washing step should be avoided in some embodiments. Rather, if it is desired to remove surface chemicals which remain after intercalation, drying processes such as centrifugal drying, freeze drying, filter pressing, or the like, can be practiced in some embodiments, to at least partially remove surface chemicals without having a significant negative effect on degree of intercalation.

Once the graphite flakes are intercalated, and, if desired, exposed to a supercritical fluid and/or dried, they are exfoliated. Exfoliation should be effected by suddenly exposing the Stage I, II or III intercalated graphite flakes to high heat. In certain embodiments, “suddenly” means that the flakes are brought from a temperature at which the selected GIC is stable to a temperature substantially above its decomposition temperature within a period of less than about 1 second; in some embodiments less than about 0.5 second; and in other embodiments less than about 0.1 second, to achieve the rapid exfoliation desired for complete separation of at least a plurality of graphene layers.

Hot contact exfoliation processes, where the flake is directed contacted by a heat source, are not employed in certain embodiments since during hot contact exfoliation the first exfoliated flakes tend to act as insulators and insulate the balance of the flakes (and thereby inhibit exfoliation). Generating heat within the GIC, for example using an arc, high frequency induction, or microwave, etc. is employed in embodiments of this disclosure. The extreme heat of a gas plasma due to temperature (thousands of degrees C.) and the turbulence which would displace the exfoliate is used in some embodiments. The temperature of exfoliation is at least about 1500° C. in some embodiments, and in certain embodiments, the temperature of exfoliation is between about 1500° C. and 2500° C.

During exfoliation, the intercalant inserted between the graphene layers of the graphite (such as between each graphene layer, as in the case of Stage I intercalation) rapidly vaporizes and literally “blows” the graphene layers apart, with such force that at least some of the graphene layers separate from the exfoliated flake, and form graphitic nano-structures.

Exfoliation can be accomplished in certain embodiments by feeding the Stage I, II or III GICs into a reaction zone which includes a region where the temperature is at least about 2500° C.; of course, this is provided that the graphite intercalation compound does not reach a temperature of greater than 2500° C. to avoid degradation of the graphite. This can be accomplished by feeding the GICs through a reaction zone having an inert gas plasma therein, or directly into an arc, to provide the high temperature environment needed for greatest expansion. In some embodiments, exfoliation occurs in a reducing gas environment, such as hydrogen, to adsorb the reducing gas onto active sites on the graphene layers to protect the active sites from contamination during subsequent handling.

In embodiments, the individual graphene layers can then be collected by conventional means, such as by centrifugal collectors, and the like. Contrariwise, in other embodiments, the stream of exfoliated/exfoliating GICs as described above can be directed at a suitable support for collection of the individualized graphene layers.

It is anticipated that some of the individual graphene layers, as they separate from the exfoliated flake, or sometime thereafter, will spontaneously assume a three-dimensional shape, such as a buckyball, while the remainder remain as flat plates. In either case, the separation of individual graphene layers from the GICs during or immediately after exfoliation results in the production of graphitic nano-structures.

### Processes

In accordance with the present disclosure, reducing the detectable cross-section of an object (which, for the purposes of this disclosure, includes eliminating the detectable cross-section of an object) includes applying graphite to the surface of the object, where the graphite comprises graphite flakes, particles of exfoliated graphite, graphitic nano-structures, or combinations of one or more thereof. In certain embodiments, the graphite is applied to the surface of the object via a coating composition which can be, in some embodiments, a paint, a primer, or an overcoat.

The coating composition in which the graphite is dispersed for application to the object can be any which is suitable for application to a mobile object such as an aircraft, manned or unmanned (such as a jet, missile, drone, etc.), a water vehicle (such as a boat, ship, or submarine, etc.), a land vehicle (such as an automobile, truck, all-terrain vehicle, armored car or truck, tank, etc.), or a stationary object such as a building or structure for which a reduced detectable cross-section is desired.

Exemplary coating compositions for dispersal of the graphite include resinous binders such as epoxy resins or paints, and urethane coatings. Indeed, any coating composition in which the graphite can be dispersed and which is capable of application and adhesion (with or without a primer coating) to the object can be employed.

The graphite is dispersed in the coating composition at a level of about 5 to about 170 parts by weight of graphite per 100 parts by weight of composition; in some embodiments, the graphite is dispersed in the coating composition at a level of about 10 to 140 parts of graphite per 100 parts of composition. In other embodiments, the graphite is present in the composition at a level of about 15 to about 120 parts by weight per 100 parts by weight of coating composition. In still other embodiments, the graphite is present at a level of about 30 parts by weight to about 100 parts by weight per 100 parts by weight of coating composition. The specific level of graphite can be adjusted in accordance with the object to which it is being applied. For instance, given the speed at which certain aircraft travel and the need for a smooth surface for aerodynamic reasons, as lower level of graphite (such as 10 to about 80 parts by weight per 100 parts of composition) may be employed in some embodiments. Contrariwise, for a stationary object, a higher level of graphite (such as 30 to 140 parts by weight per 100 parts of composition) may be employed in some embodiments. In embodiments, the graphite is randomly dispersed in the coating composition, so as not to adopt a uniform orientation. In other words, the graphite flakes are oriented in different directions with respect to each other.

The coating composition can also, in some embodiments, contain additional elements, such as diluents, pigments, dispersing agents, fillers, anticorrosion agents or fillers, curing agents, rheological additives, coupling agents, and the like which would be familiar to the skilled artisan. In addition, in some embodiments, additional materials which can assist in the reduction of the cross-section of an object can also be dispersed in the coating composition as a supplement to the graphite. Such materials can include metals such as aluminum, copper, nickel, and iron, in the form of particles or a metallic paste. When included, any such metals can be present at a level of about 2 to about 30 parts by weight per 100 parts of the coating composition, in some embodiments.

Once the coating composition having graphite dispersed thereinto is formed, it is applied to the surface of the object by conventional methods, such as by spraying, dipping, brushing, etc. In one embodiment, the coating is applied to the object by spraying. The application is then followed, in some embodiments, by a drying or curing step.

The unique characteristics of the graphite employed in the present disclosure can effectively reduce the detectable cross—section of an object. More specifically, it is believed that the crystalline and planar nature of graphite flakes, the graphene layers of particles of exfoliated graphite, and graphitic nano-structures can both absorb radar and/or other detection beams as well as deflect some of what is not absorbed. The randomized orientation of the graphite in the composition (by which is meant that all the graphite is not oriented in a planar direction when dispersed in the coating composition) means deflection will be in a multitude of directions, rather than primarily in a direction returning back to the source. Indeed, the vermiform nature of particles of exfoliated graphite, with their “accordion” or “worm” shape can randomize the deflection of any radar or other detection beam.

Moreover, the anisotropic nature of the graphite cant also help to spread any heat generated and thus reduce infrared detection. Also, in some embodiments, at higher loading levels (i.e., at levels in the coating composition of 50 parts by weight of graphite per 100 parts by weight of coating composition, or more), the radio frequency shielding properties of graphite can help reduce detection of radio frequency or radio frequency interference (rfi).

All combinations of method or process steps as used herein can be performed in any order, unless otherwise specified or clearly implied to the contrary by the context in which the referenced combination is made.

The methods and materials of the present disclosure, including components thereof, can comprise, consist of, or consist essentially of the essential elements and limitations of the embodiments described herein, as well as any additional or optional ingredients, components or limitations described herein or otherwise useful in compositions for reducing the detectable cross-section of an object.

### FORMULATION EXAMPLES

### Example 1

A coating composition is prepared by combining together:

68 parts by weight polyurethane resin binder;

12 parts by weight polytetrafluorethylene pigment filler;

15 parts by weight black color paste; and

5 parts by weight xylene diluent.

Into the coating composition is dispersed 70 parts by weight of graphite flakes to provide a composition in accordance with this disclosure.

### Example 2

A coating composition is prepared by combining together:

34 parts by weight epoxy resin;

16 parts by weight polytetrafluorethylene pigment filler;

18 parts by weight black color paste;

12 parts by weight xylene diluent;

20 parts by weight zinc phosphate anticorrosion filler.

Into the coating composition is dispersed 40 parts by weight of particles of exfoliated graphite to provide a composition in accordance with this disclosure.

### Example 3

A coating composition is prepared by combining together:

63 parts by weight urethane resin;

12 parts by weight polytetrafluorethylene pigment filler;

10 parts by weight black color paste;

8 parts by weight xylene diluent;

7 parts by weight zinc phosphate anticorrosion filler.

Into the coating composition is dispersed 30 parts by weight of graphitic nano-structures to provide a composition in accordance with this disclosure.

The foregoing examples are embodiments of stealth coatings of the present disclosure, and are not intended to be limiting. Any modifications, equivalents, improvements, etc., which are within the spirit and scope of the present disclosure are intended to be included.

All references cited in this specification, including without limitation, all patents, patent applications, and publications, and the like, are hereby incorporated by reference into this specification in their entireties. The discussion of the references herein is intended merely to summarize the assertions made by their authors and no admission is made that any reference constitutes prior art. Applicant reserves the right to challenge the accuracy and pertinence of the cited references.

Although embodiments of the disclosure have been described using specific terms and processes, such description is for illustrative purposes only. The words used are words of description rather than of limitation. It is to be understood that changes and variations may be made by those of ordinary skill in the art without departing from the spirit or the scope of the present disclosure, which is set forth in the following claims. In addition, it should be understood that aspects of the various embodiments may be interchanged in whole or in part. Therefore, the spirit and scope of the appended claims should not be limited to the description of the versions contained therein.

What is claimed is:

1. A composition for reducing the detectable cross-section of an object, which comprises graphite selected from the group consisting of graphite flakes, particles of exfoliated graphite, graphitic nano-structures, and combinations of one or more thereof, wherein the graphite is dispersed in a coating composition.

2. The composition of claim 1, wherein the graphite comprises graphite flakes having a degree of graphitization of about 1.0, particles of exfoliated graphite produced from graphite flakes having a degree of graphitization of about 1.0, graphitic nano-structures produced from graphite flakes having a degree of graphitization of about 1.0, and combinations of one or more thereof.

3. The composition of claim 2, wherein the graphite comprises graphite flakes having a purity of at least about 98%, particles of exfoliated graphite produced from graphite flakes having a purity of at least about 98%, graphitic nano-structures produced from graphite flakes having a purity of at least about 98%, and combinations of one or more thereof.

4. The composition of claim 1, wherein the graphite is present at a level of about 5 to about 170 parts by weight per 100 parts by weight of coating composition.

5. The composition of claim 4, wherein the graphite is present at a level of about 30 to about 100 parts by weight per 100 parts by weight of coating composition.

6. The composition of claim 1, wherein the graphite is randomly dispersed in the coating composition.

7. The composition of claim 1, which further comprises metals selected from the group consisting of aluminum, copper, nickel, iron, and combinations thereof, wherein the metals are dispersed into the coating composition.

8. The composition of claim 7, wherein metals are present at a level of about 2 to about 30 parts by weight per 100 parts of the coating composition.

9. An object having applied to a surface thereof a composition for reducing the detectable cross-section of an object, wherein the composition comprises graphite selected from the group consisting of graphite flakes, particles of exfoliated graphite, graphitic nano-structures, and combinations of one or more thereof, wherein the graphite is dispersed in a coating composition.

10. The object of claim 9, wherein the graphite comprises graphite flakes having a degree of graphitization of about 1.0, particles of exfoliated graphite produced from graphite flakes having a degree of graphitization of about 1.0, graphitic nano-structures produced from graphite flakes having a degree of graphitization of about 1.0, and combinations of one or more thereof.

11. The object of claim 10, wherein the graphite comprises graphite flakes having a purity of at least about 98%, particles of exfoliated graphite produced from graphite flakes having a purity of at least about 98%, graphitic nano-structures produced from graphite flakes having a purity of at least about 98%, and combinations of one or more thereof.

12. The object of claim 9, wherein the graphite is present at a level of about 5 to about 170 parts by weight per 100 parts by weight of coating composition.

13. The object of claim 12, wherein the graphite is present at a level of about 30 to about 100 parts by weight per 100 parts by weight of coating composition.

14. The object of claim 9, wherein the graphite is randomly dispersed in the coating composition.

15. The object of claim 10, wherein the composition further comprises metals selected from the group consisting of aluminum, copper, nickel, iron, and combinations thereof, wherein the metals are dispersed into the coating composition.

16. The object of claim 9, which comprises an aircraft, a water vehicle, a land vehicle, or a stationary object.

17. A process for reducing the detectable cross-section of an object, which comprises applying to a surface of the object graphite selected from the group consisting of graphite flakes, particles of exfoliated graphite, graphitic nano-structures, and combinations of one or more thereof, wherein the graphite is dispersed in a coating composition.

18. The process of claim 17, wherein the graphite comprises graphite flakes having a degree of graphitization of about 1.0, particles of exfoliated graphite produced from graphite flakes having a degree of graphitization of about 1.0, graphitic nano-structures produced from graphite flakes having a degree of graphitization of about 1.0, and combinations of one or more thereof.

19. The process of claim 18, wherein the graphite comprises graphite flakes having a purity of at least about 98%, particles of exfoliated graphite produced from graphite flakes having a purity of at least about 98%, graphitic nano-structures produced from graphite flakes having a purity of at least about 98%, and combinations of one or more thereof.

20. The process of claim 17, wherein the coating composition having graphite dispersed thereinto is applied to the object by spraying.
